(19) United States
(12) Patent Application Publication
(10) Pub. No.: US 2017/0367303 A1
(43) Pub. Date: Dec. 28, 2017

(54) SHOCK-ABSORBING ANIMAL LEASH

(71) Applicant: Pullnot Leash Inc., Pacifica, CA (US)

(72) Inventor: Allam Bitar, Pacifica, CA (US)

(21) Appl. No.: 15/619,890

(22) Filed: Jun. 12, 2017

Related U.S. Application Data
(63) Continuation-in-part of application No. 29/569,542, filed on Jun. 28, 2016.
Application No. 29/569,542 is a continuation-in-part of application No. 29/569,547, filed on Jun. 28, 2016.
Application No. 29/569,547 is a continuation-in-part of application No. 29/599,540, filed on Apr. 4, 2017.

(51) Int. Cl. A01K 27/00

(52) U.S. Cl. CPC A01K 27/005; A01K 27/003

(57) ABSTRACT

Using various embodiments, methods and apparatuses for a shock-absorbing leash are described. In one embodiment, the shock-absorbing leash comprises a handle portion, a cord of predetermined length, a coiled spring coupled to the cord, a gripping sheath configured to cover at least a portion of the cord and/or provide support, by creating a tight/snug fit, to a coiled spring that is located underneath the cord, and a latch assembly coupled to the coiled spring. The latch assembly is configured to be coupled to a collar or harness of an animal.

### CROSS REFERENCE TO RELATED APPLICATIONS

The present application is a continuation in part of, and claims priority from, U.S. Design patent application Ser. No. 29/569,542 filed on Jun. 28, 2016 and entitled “Anti-Pull Dog Leash With Dual Springs,” U.S. Design patent application Ser. No. 29/569,547 filed on Jun. 28, 2016 and entitled “Spring Based Anti-Pull Dog Leash,” and U.S. Design patent application Ser. No. 29/599,540 filed on Apr. 4, 2017 and entitled “Animal Leash With Spring,” the contents of which are incorporated herein by reference.

### FIELD OF THE INVENTION

Embodiments of the present invention relates generally to the field of animal leashes. More particularly, embodiments of the invention relate to animal leashes that can mitigate sudden force or shock made by the animal by absorbing the sudden force or shock.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Animal restraining devices (e.g., pet leashes) assist a user of the restraining device to control or restrict the movements of an animal. Such devices involve the user to exert physical strength over the animal in restricting/controlling the animal's movements. Typically, the physical strength required to control the movements of the animal depends on the size and weight of the animal; the bigger/heavier the animal, more strength would be required to successfully control its movements by the user of the restraining device. Further, when the animal suddenly exerts force (jerk movement), the sudden momentum generates a shock to the user that can result in physical injury. Thus, what is needed is a leash equipped to restrain animals, and that can mitigate sudden force or shock caused by the animal.

### SUMMARY OF THE DESCRIPTION

Embodiments of the present invention are best understood by reference to the detailed figures and description set forth herein. Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive. Compounds, materials, manufacturing techniques, uses, and applications, described herein, as these may vary.

It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. It is to be further understood that the present invention is not limited to the particular methodology in the art. Similarly, for another example, a reference to “a step” or “a means” is a reference to one or more steps or means and may include sub steps and subservient means.

All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Using various embodiments, a shock absorbing (or damping) animal leash is described. In one embodiment, the shock absorbing leash comprises a handle portion, a cord having a predetermined length, a coiled spring, the coiled spring coupled to the cord, a sheath configured to provide extra support to and/or gripping the coiled spring, the sheath/covering at least a portion of the cord (and/or coiled spring), and a latch coupled to the coiled spring, where the latch configured to be coupled to a collar or harness of an animal. In one embodiment, the gripping effect caused by the sheath prevents unintentional displacement of the coiled spring within the cord. In another embodiment, the handle portion and the cord portion of the leash are made from a single and/or continuous elastic tubing or vestibule. In yet another embodiment, the shock-absorbing animal leash further comprises a side aperture located in proximity to a first end of the elastic tubing, the elastic tubing having a first opening located at the first end, and a second opening located at a second end. In this embodiment, the handle portion is formed by passing the second end of the elastic tubing through the side aperture and the first opening.

In another embodiment of the shock-absorbing animal leash, a second opening of the elastic tubing can be configured to accommodate the coiled spring. The shock-absorbing animal leash can also comprise a second sheath configured to cover the side aperture and the first opening. In one embodiment, the elastic tubing can be made from natural latex rubber, natural rubber, or a combination thereof. In one embodiment, the coiled spring is configured to extend upon receiving a sudden force or shock from an animal wearing a collar or harness that is coupled to the leash. In yet another embodiment, the elastic tubing can be configured to extend/flex upon receiving a sudden force or shock from the animal wearing the collar or harness.

In another embodiment, an animal leash is described comprising an elastic tubing having a first and second opening located at a first and second end of the elastic tubing, respectively, the elastic tubing having a slit or aperture to accommodate passing the second end through the slit and first opening to form a handle portion of the leash. The leash further comprises a first sheath covering the first opening of the elastic tubing and the slit or aperture. The first sheath can be configured to provide a tight fit over the first opening and/or the slit/aperture to provide additional support (to prevent the formed handle from being displaced due to sudden force/jerk caused by the animal or the leash holder. The leash further includes a coiled spring configured to be accommodated within the elastic tubing at the second opening, and a latch coupled to the coiled spring at one end and a collar or harness of an animal at another end.

### BRIEF DESCRIPTION OF THE DRAWINGS

The present invention is illustrated by way of example and not limitation in the figures of the accompanying drawings in which like references indicate similar elements.

FIG. 1 illustrates a first embodiment of a shock absorbing animal leash, according to the present invention.

FIG. 2 illustrates a second embodiment of a shock absorbing animal leash, according to the present invention.

FIG. 3 illustrates a third embodiment of a shock absorbing animal leash, according to the present invention.

FIG. 4 illustrates an exploded view of the third embodiment described in FIG. 3, according to the present invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention.

Structures described herein are to be understood also to refer to functional equivalents of such structures. The present invention will now be described in detail with reference to embodiments thereof as illustrated in the accompanying drawings. From reading the present disclosure, other variations and modifications will be apparent to persons skilled in the art. Such variations and modifications may involve equivalent and other features which are already known in the art, and which may be used instead of or in addition to features already described herein. Although claims may have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention.

A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced; reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation. The present invention will now be described in detail with reference to embodiments thereof as illustrated in the accompanying drawings.

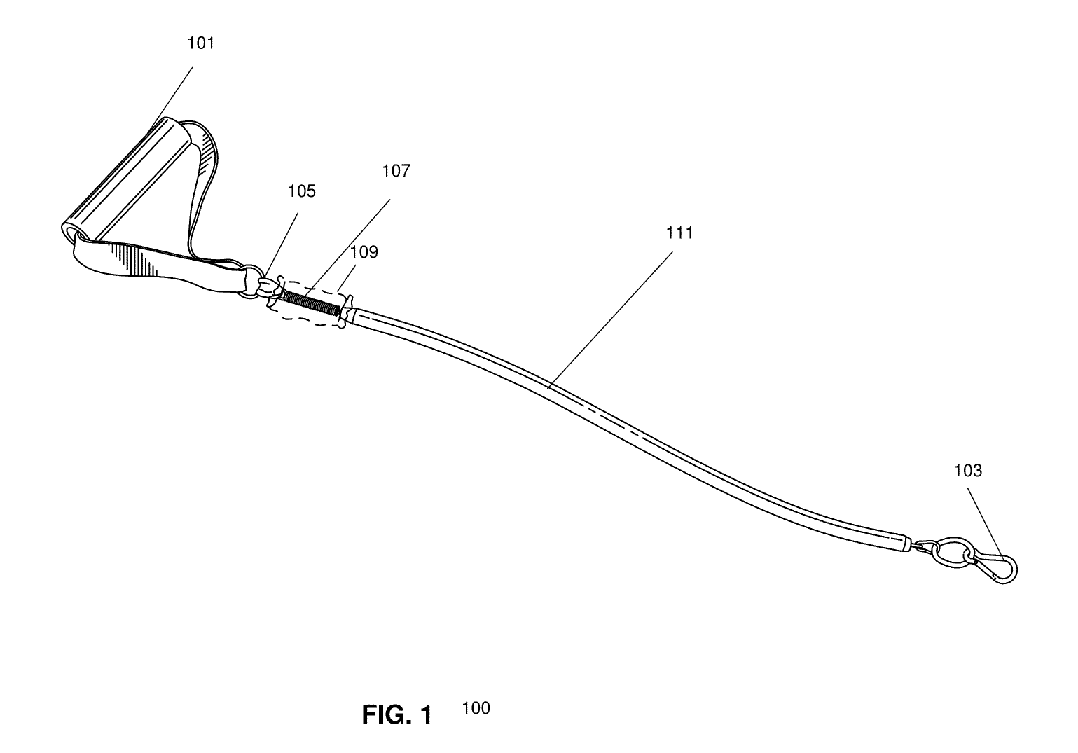

FIG. 1 illustrates a first embodiment of a shock absorbing animal leash 100, according to the present invention. As illustrated, shock absorbing animal leash 100 can comprise handle 101 coupled to spring 107, via ring or latch 105. In one embodiment, animal leash 100 further includes a protective covering/sheath 109 (shown with a dashed line) configured to prevent contact between the user and spring 107. In one embodiment, animal leash 100 can further comprise a strap or cord 111 coupled to spring 107. Spring 107 can have a top distal end that is coupled to handle 101 and a bottom distal end coupled to strap 111. In one embodiment, a lower end of cord 111 is coupled to a ring or latch assembly 103 configured to be coupled to an animal's collar. In one embodiment, cord 111 is made up of natural rubber, synthetic rubber, latex (natural or synthetic), polyurethane, thermoplastic elastomer (TPE), or any combination thereof. A person of ordinary skill in the art would appreciate that to implement the techniques described herein, spring 107 can be coupled to either the upper or lower distal end of cord 111.

Generally, cord 111 can constructed using any material(s) that has elastic properties when subjected to sudden force or movements. Cord 111 can be configured to be a strap, tube, vestibule, chain, etc. Depending on the flexibility and sudden force that a leash may have to withstand, various embodiments can have different measurements/characteristics for spring 107 and/or cord 111. Thus, a person of ordinary skill in the art would appreciate that the compression, extension, die, and torsion properties of a spring can be adjusted/changed, based on the user's need (which can generally be defined based on the type of animal—size, weight, breed, etc. —for which animal leash 100 is intended to be used). Further spring 107 may or may not have a hook on one or both sides, as illustrated in various embodiments herein. In one embodiment, spring 107 can be coiled, uncoiled, or a combination thereof. In one embodiment, a protective covering or sheath 109 can be used to protect spring 107. Protective sheath 109 can be, in one embodiment, used to protect accidental contact of the user and/or any part of the animal (e.g., animal fur) with spring 107, since spring 107 can suddenly expand and compress, and without a protective sheath contact with a user/animal during the sudden expansion-compression can cause injury/discomfort to either the user or the animal, depending on the location of spring 107. In one embodiment, cord 111 can be coupled to a latch or ring assembly 103 that can be configured to be coupled to an animal collar or harness.

In yet another embodiment, cord 111 can include two segments, segment 1 and segment 2, each segment having an upper and lower distal end. In this embodiment, the lower distal end of segment 1 and be coupled to the upper distal end of segment 2. In this embodiment, cord 111 can be coupled directly to ring 105 at the upper distal end of one segment of cord 111, and latch assembly 103 can be directly coupled to the lower distal end of the second segment of cord 111.

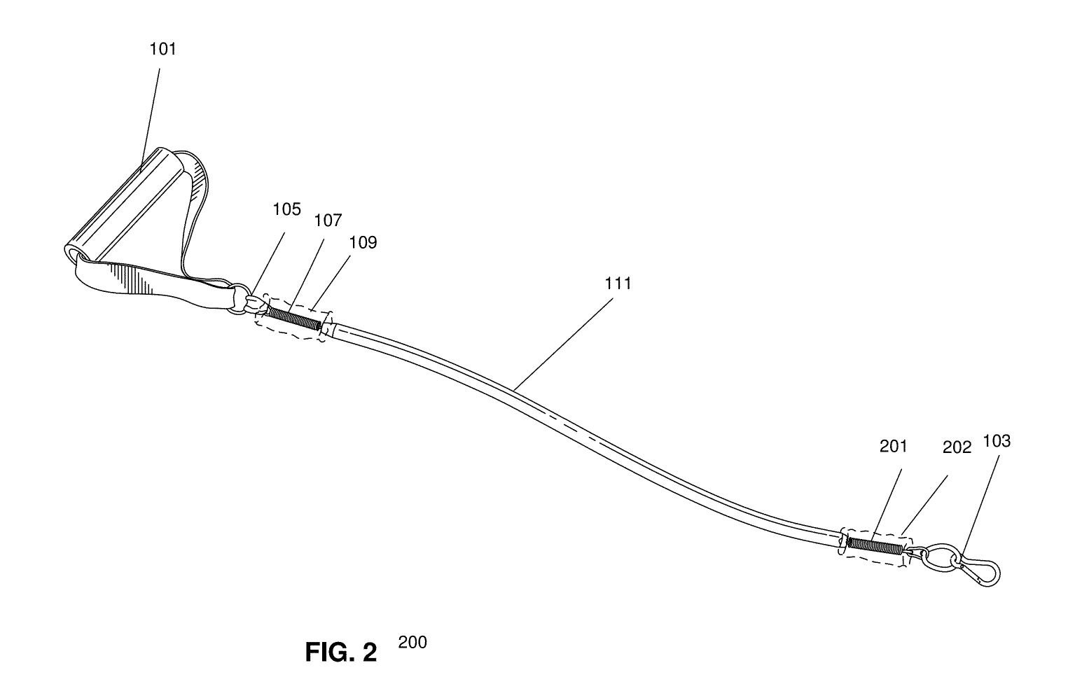

FIG. 2 illustrates a second embodiment of a shock absorbing animal leash 200, according to the present invention. As illustrated, animal leash 200 comprises a plurality of springs, spring 107 and spring 201, as illustrated. Such an embodiment can be used when leash 200 is used with a large animal, and thus, more than one spring can be used in tandem. A tandem configuration can be helpful in distributing the sudden shock or force evenly across the leash (as opposed to having a plurality of springs 107 connected with a parallel configuration to chord 111). In one embodiment, a parallel configuration (that is, when two or more spring are together connected to the same ending of cord 111) can be employed for further strengthening the leash in conjunction with the tandem configuration as illustrated in FIG. 2.

As illustrated, in one embodiment, cord 111 is coupled to spring 201. Spring 201 is coupled to latch assembly 103, as illustrated. Further spring 201 can have a protective sheath 202 that can further protect the animal, or part thereof (e.g., fur), from coming in accidental contact with spring 201.

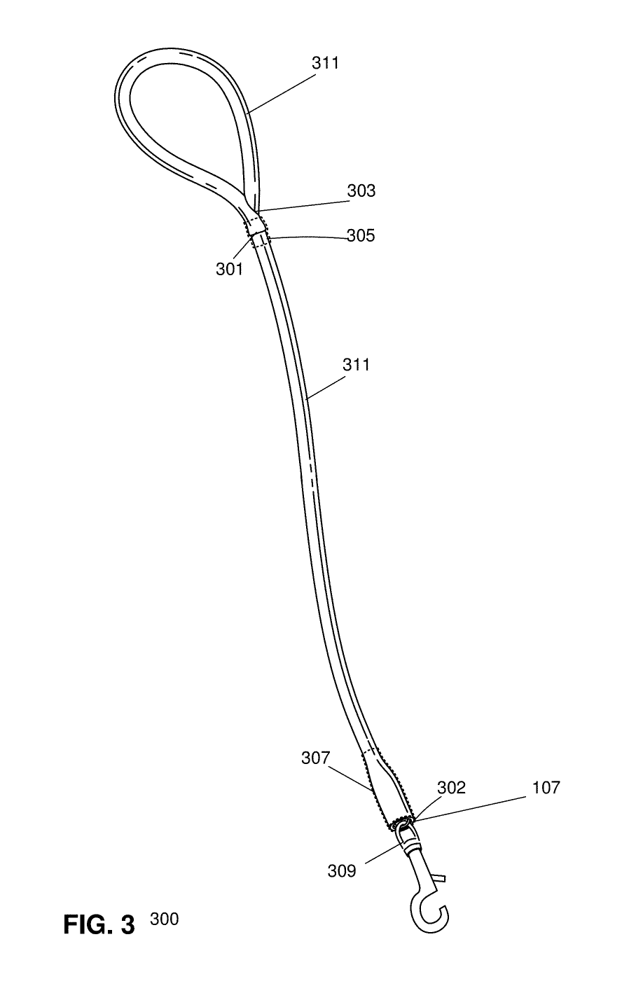

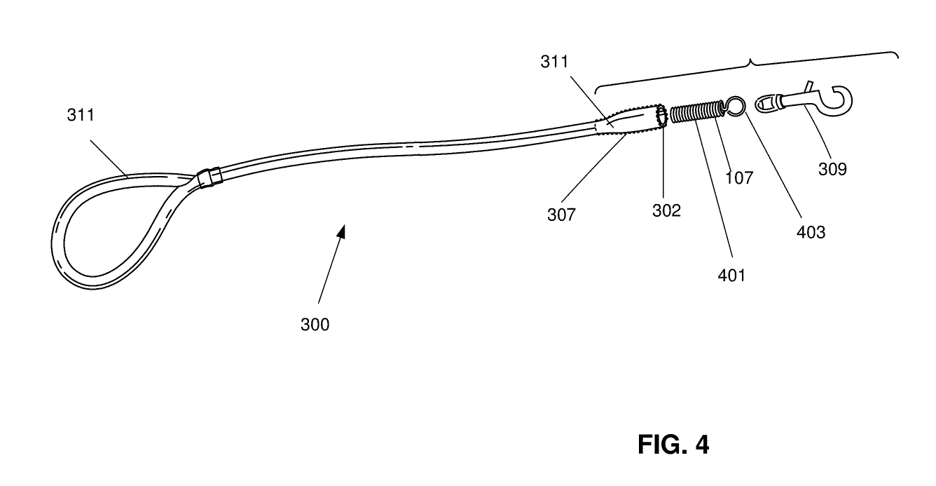

FIG. 3 illustrates a third embodiment of a shock absorbing animal leash, according to the present invention. As illustrated, animal leash 300, in one embodiment, can comprise a single tubing that forms the handle and cord section of a leash. In a preferred embodiment, tubing 311, comprising an upper distal end having opening 301 and a lower distal end having opening 302, can be tubular in shape. In one embodiment, tubing 311 comprises an elastic and/or stretchable material comprising rubber (natural or synthetic), latex, or any combination thereof. In one embodiment, tubing 311 can be made from surgical tubing. Tubing 311 can further include side aperture 303 in close proximity to opening 301. In one embodiment, side aperture 303 is located on tubing 311 at a distance of between 0.15 inches and 2 inches from opening 301. In order to form the handle of animal leash 300, as illustrated, the lower distal end (and opening 302) can be passed through side aperture 303 from the exterior side of tubing 311, and then passed through opening 301 (from the interior of tubing 311) to form a loop, as illustrated. The lower distal end of tubing 311 can then be pulled through opening 301, to a predetermined length, to form the cord portion of a leash and/or to determine the size of the loop to form the handle portion of the leash. After a desired size of the loop is determined to form the handle, at least one gripping sheath 305 (shown as dashed line) can be employed to cover side aperture 303 and opening 301, in one embodiment. Gripping sheath 305, in one embodiment, can have a tightly closed/snugged fit to prevent intentional/accidental movement of the formed loop (and to ensure the required length of the handle is not compromised due to the pull caused by an animal). In one embodiment, spring 107 can be inserted into tubing 311 from opening 302. Spring 107 can be, in one embodiment, at least partly exposed from the opening 302 of tubing 311. Spring 107 can be connected to latch assembly 309, as further illustrated in FIG. 4. Lower distal end of tubing 311, in one embodiment, can have gripping sheath 307 that covers at least a portion of tubing 311 and/or spring 107 and opening 302. In another embodiment, spring 107 is completely inserted into tubing 311, and gripping sheath 307 provides additional support in ensuring spring 107 is not displaced from its intended position (e.g., due to the sudden pull movement from the animal, or by a user). Gripping sheath 307 can also cover at least a part of latch assembly 309. Gripping sheath 307, in one embodiment, can have a tightly closed/snugged fit to prevent intentional/accidental displacement/movement of spring 107. In one embodiment, gripping sheath 307 can also ensure protection of the welfare of the animal to avoid accidental contact (e.g., with fur of the animals) of spring 107 and/or latch assembly 309. In one embodiment, gripping sheaths 305 and 307 are constructed from an elastic/stretchable material comprising at least one of latex, natural rubber, synthetic rubber, polyurethane, thermoplastic elastomer, or any combination thereof. Gripping sheaths, in one embodiment, 305 and/or 307, act as supporting structures because of their elastic properties by providing a uniform inward pressure when each sheath is stretched and placed over tubing 311. Thus, in one embodiment, gripping sheaths 305 and/or 307 are configured to be in at least a partially stretched form when coupled to, or placed over, tubing 311, as illustrated in FIG. 3.

FIG. 4 illustrates an exploded view of the third embodiment described in FIG. 3, according to the present invention. As illustrated, spring 107 can be configured to have an exposed hook 403 and a coiled body 401. Hook 403 (also referred to as loop by a person of ordinary skill in the art), in one embodiment can be coupled to latch assembly 309. As illustrated, at least a portion of coil 401 can be inserted into tubing 311 from opening 302. In one embodiment, hook 403 can also be at least partly (or completely) inserted into chord 111 from opening 302. In one embodiment, hook 403 can be coupled to latch assembly 309. Latch assembly 309 can be configured to be coupled to a collar or harness of an animal. Gripping sheath 307 (illustrated with a dashed line), can be imposed over tubing 311 to cover any portion of spring 107 that has not been covered by tubing 311. In one embodiment, gripping sheath 307 can at least cover a portion of latch assembly 309. Gripping sheath 307 can also be configured to have a snugged fit over chord 111 to prevent accidental contact of the animal/animal fur with spring 107 and/or latch assembly 309 while spring 107 is being expanded or contracted/compressed. In another embodiment, gripping sheath 307 provides additional support to spring 107 to avoid intentional/accidental displacement or movement of spring 107.

Without limitation, in an exemplary embodiment, spring 107 can have a hook/loop 403 on one side and an end coil pressed into the coiled body 401. In one embodiment, hook 403 can be at least be partly exposed from gripping sheath 307. In another embodiment, hook 403 is completely covered by tubing 311. Spring 107 can have a coil diameter between 0.4 and 0.8 inches, and a spring rate between 40 to 70 lbf/in (pound-force per inch). In one embodiment, spring 107 can have an initial tension between 12 and 17 lbf (pound force). Coiled body 401, at a state of rest, can have a length between 1.3 and 2.2 inches and have between 14-23 coils. In one embodiment, tubing 311 can comprise of food grade natural latex rubber, Sulfer, Zinc Oxide, or any combination thereof. Tubing 311 can, in one embodiment, have a tensile property of between 3000 and 3500 PSI (minimum); an ultimate elongation between 500-1,000% (minimum), its 100% Modulus at between 90 and 150 PSI (average); and Specific Gravity of between 0.8-0.96 Grams/cc.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing the invention described herein will be apparent to those skilled in the art. Various aspects of the invention have been described above by way of illustration, and the specific embodiments disclosed are not intended to limit the invention to the particular forms disclosed.

The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Thus, apparatuses for a shock-absorbing animal leash are described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A shock-absorbing animal leash comprising:
a handle portion;
a cord having a predetermined length;
a coiled spring, the coiled spring coupled to the cord;
a first sheath covering at least a portion the cord, the first sheath configured to grip the coiled spring from over the cord; and
a latch coupled to the coiled spring, wherein the latch is configured to be coupled to a collar or harness of an animal.

2. The shock-absorbing animal leash of claim 1, wherein the handle portion and the cord are made from a single continuous elastic tubing or vestibule.

3. The shock-absorbing animal leash of claim 2, further comprising a side aperture located in proximity to a first end of the elastic tubing, wherein the elastic tubing has a first opening located at the first end, and a second opening located at a second end, and wherein the handle portion is formed by passing the second end of the elastic tubing through the side aperture and the first opening.

4. The shock-absorbing animal leash of claim 3, wherein the second opening of the elastic tubing is configured to accommodate the coiled spring.

5. The shock-absorbing animal leash of claim 3, further comprising a second sheath, the second sheath configured to cover the side aperture and the first opening.

6. The shock-absorbing animal leash of claim 1, wherein the elastic tubing made from natural latex rubber.

7. The shock-absorbing animal leash of claim 1, wherein the first sheath is further configured to prevent movement or displacement of the coiled spring.

8. The shock-absorbing animal leash of claim 1, wherein the coiled spring is configured to extend upon receiving a force or shock from an animal wearing the collar.

9. The shock-absorbing animal leash of claim 1, wherein the coiled spring can have a hook on one side and an end coil pressed into the coiled spring on the other end, wherein the hook is configured to be coupled to the latch.

10. The shock-absorbing animal leash of claim 9, wherein the hook is exposed from the first sheath.

11. An animal leash comprising:
an elastic tubing having a first and second opening located at a first and second end of the elastic tubing, respectively, the elastic tubing having a slit or aperture to accommodate passing the second end through the slit and first opening;
a first sheath covering the first opening of the elastic tubing and the slit or aperture;
a coiled spring configured to be accommodated within the elastic tubing at the second opening; and
a latch coupled to the coiled spring at one end and a collar or harness of an animal at another end.

12. The animal leash of claim 11, further comprising a second sheath, the second sheath configured to cover at least a portion of the cord, the second sheath configured to provide support to the coiled spring.

13. The animal leash of claim 11, wherein the elastic tubing made from natural latex rubber.

14. The animal leash of claim 11, wherein the coiled spring is configured to extend upon receiving a force or shock from an animal wearing the collar.

15. The animal leash of claim 11, wherein the elastic tubing is configured to extend upon receiving a force or shock from an animal wearing the collar.

16. The animal leash of claim 11, wherein the coiled spring can have a hook on one side and an end coil pressed into the coiled spring on the other end, wherein the hook is configured to be coupled to the latch.

17. The animal leash of claim 16, comprising a second sheath, the second sheath configured to cover at least a portion of the coiled spring the hook is exposed from the second sheath.

18. The animal leash of claim 11, wherein a handle portion is formed by passing the second end of the elastic tubing through the side aperture and the first opening, pulling the second end to a predetermined length to form a cord portion of the animal leash.
